(19) United States
(12) Patent Application Publication
(10) Pub. No.: US 2020/0005078 A1
(43) Pub. Date: Jan. 2, 2020

(54) CONTENT AWARE FORENSIC DETECTION OF IMAGE MANIPULATIONS

(71) Applicant: Honeywell International Inc., Morris Plains, NJ (US)

(72) Inventors: Asongu Tambo, Plymouth, MN (US); Michael Albright, Minneapolis, MN (US); Scott McCloskey, Minneapolis, MN (US)

(21) Appl. No.: 16/400,542

(22) Filed: May 1, 2019

Related U.S. Application Data
(60) Provisional application No. 62/693,212, filed on Jul. 2, 2018.

(51) Int. Cl. G06K 9/62; G06K 9/46

(52) U.S. Cl. CPC G06K 9/6215; G06K 9/4609; G06K 9/6261; G06K 9/6218; G06K 9/4671

(57) ABSTRACT

A process identifies features in a probe image and a donor image. A similarity measure matches the features in the probe image with features in the donor image, and forms pairs of matched features. The process then forms clusters of the pairs based on the pairs occupying a similar location in the probe image, and verifies that the clusters in the probe image are good fits for corresponding features in the donor image. Locations of the clusters and locations of the corresponding features are marked, and the extent to which the clusters and the corresponding features represent the same semantic class. The process calculates a score based on clusters having the good fit and the clusters in the first digital image having a similar semantic interpretation as the corresponding cluster in the second digital image.

### RELATED APPLICATIONS

The present application claims priority to U.S. Serial Application No. 62/693,212, the content of which is incorporated herein by reference in its entirety.

### GOVERNMENT INTEREST

This invention was made with Government support under Contract FA8750-16-C-0190 awarded by the Air Force. The Government has certain rights in this invention.

### TECHNICAL FIELD

The present disclosure relates to content aware forensic detection of image splicing manipulations.

### BACKGROUND

It is now easier than ever to produce realistic-looking image manipulations, both with photo editing software and in-camera manipulations with computational cameras. Determining the images that were used to contribute image data to another image is known as the Providence Problem. Detecting such manipulations is often done manually, but this does not scale to the numbers of images posted to online platforms every day. Among the many types of image manipulations, splice and copy-move manipulations are commonly used to misrepresent the presence or the number of objects in a particular location, and are thus of particular interest.

### BRIEF DESCRIPTION OF THE DRAWINGS

FIG. 1 is a diagram of an image forgery detection method.

FIG. 2 is another diagram of an image forgery detection method.

FIG. 3 is a plot illustrating discrepancy between scaling factors varying with patch radius.

FIG. 4 is an example of a convolutional neural network.

FIG. 5 is a block diagram of a hardware system upon which one or more embodiments of the present disclosure can execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

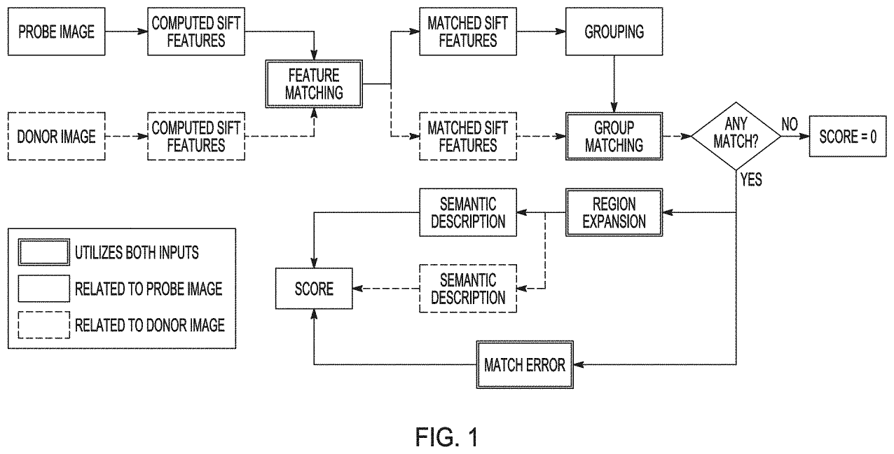

An embodiment determines whether some pixels of an image (probe) are from another image (donor), i.e., has the probe image been manipulated by including parts of the donor image. FIG. 1 outlines the main steps of an approach of forgery detection. At a high level, SIFT feature matches are used for speed as a basis, and requirements are imposed on the matches to reduce false alarms. First, the matched features have to form a spatial group with a geometric transformation, and second, the regions underlying the matching features must have similar semantic meanings.

An embodiment relates to the splice detection problem, supporting the estimation of an image's phylogeny. In this context, the detection problem is to determine, given two images, whether one image (referred to as the ‘probe’) contains pixels spliced in from a second image (referred to as the ‘donor’). A key consequence of the two input framing is that a set of N images gives rise to N²−N trials, which can be quite large when images are sourced from online platforms. This necessitates solutions which are fast and, assuming that the number of spliced images M«N, where false alarms are extremely rare so as not to outnumber the true detections.

While deep learning approaches are ubiquitous in computer vision, the computational complexity of applying them to large online image collections is daunting. As such, an embodiment leverages low-level cues such as Scale Invariant Feature Transform (SIFT) features and approximate matching to rapidly prune the vast majority of non-splice pairs, followed by deep learning powered semantic analysis to suppress the resulting false alarms. In addition to SIFT, other algorithms could be used such as SURF (Speeded Up Robust Features), or ORB (Oriented FAST and Rotated BRIEF). Specifically, an embodiment uses an object recognition neural network to filter out false positives from spurious low-level SIFT matches having accidentally-matching arrangements. As a result, an embodiment significantly out-performs previous methods in terms of both computational complexity and precision.

Given that the manipulated region still retains certain visual similarities with the source region (i.e., a copied object is still recognizable in the probe image), points of interest in the manipulated region should match those in the source region. As such, points of interest and their descriptions are extracted in both images using SIFT features. SIFT features are robust to scaling and rotation operations, and are widely used for extracting and describing interest points in an image.

If two images share patches that contain interest points, then the descriptors of these patches should match. To find matching interest points, each descriptor ζᵢ^{p}ϵZ^{p} in the probe image is compared to all descriptors Z^{d}={ζᵢ^{d}} in the donor image. A ratio test is used whereby ζᵢ^{p} matches with ζⱼ^{d} if ζ_{f}^{d} has the shortest distance to ζᵢ^{p} and this distance is less than a specified percentage of the next shortest distance. i.e.,

∥ζᵢ^{p}−ζⱼ^{d}∥<σ∥ζᵢ^{p}−ζk≠j^{d}∥ (1)

where σ=0.6, ζⱼ^{d} is the closest descriptor to ζ_{f}^{p} and ζₖ^{d} is the next closest descriptor to ζₜ^{p}. The above equation (1) implies an exhaustive search of each descriptor in one image to those in the other image. This is very time consuming and hence too slow for practical applications where it may be necessary to search millions of images. As such, an approximate nearest neighbor matching scheme is employed that significantly reduces the matching time while maintaining a high level of matching accuracy.

For each feature in the probe image, the approximate matching scheme returns a list of matching features and their distances. Equation (1) is used to determine if a strong match exists. Probe image interest points that do not have a strong match among the donor image interest points are rejected. Feature matching between the two images establishes a correspondence between interest points in the probe image to those in the donor image. This correspondence is not necessarily one-to-one as multiple points in the probe image can have the same match in the donor image.

As described above, matches between SIFT points are imperfect, so there will invariably be a significant number of incorrect matches between keypoints in donor and probe images (i.e., false positives). Hence, matching keypoints alone is insufficient to detect splice forgeries with acceptable confidence. However, it is possible to greatly suppress false matches by checking for geometric consistency between matched points in the donor and probe images. In the case of a genuine splice forgery, the keypoints from the spliced regions of the donor and probe will share a common geometric transform. For example, if a region from the probe image was copied, scaled up or down (equally in all directions), rotated, and then pasted into the donor, a single similarity transformation would describe the mapping between point locations from the donor to probe image. However, it is highly unlikely for a group of falsely matched points which are not part of genuine splice forgery to share a common geometric transform.

A grouping and filtering step is implemented to suppress false positives. This step consists of first grouping pairs of matching keypoints from the probe image into clusters, then checking if the points in the clusters share a common geometric transformation with their matches in the donor image. To determine the initial cluster locations, the probe image is divided into non-overlapping square grids. This ensures good detection coverage across the entire image, and also constrains the clustering process so that groups of keypoints share geometric proximity within the image. The size of each grid element is equal to the maximum of either 101 pixels or the radius that accounts for 2% of the image area, i.e.,

$$w = 2 \times max [ 101 , \sqrt{\frac{0.02 \times height \times width}{π}} ] \qquad ( 2 )$$

K-means clustering is performed on the interest points of the probe image using the centers of the grid elements as seed points. It is worth noting that since the size of the forged patch is unknown, the forged patch could be split over many clusters, or the entire patch could be in a single cluster. A group matching scheme is used to decide which clusters in the probe image contain regions that are present in the donor image.

Since the purpose of the group matching step is to prevent random arrangements of matched keypoints from triggering false splice detections, it is important that group matching be restricted to a class of transformations that minimally encompass actual transformations used in splice manipulations.

For each cluster X=(X₁, . . . , Xₙ): Xᵢ=(x,y)^{T} of n points in the probe image, a transform is sought that maps these points to their matches Y in the donor image. The affine homography is first considered, which takes the form

$$\begin{matrix}Y = [ \begin{matrix}{S}_{x} & 0 \\ 0 & {S}_{y}\end{matrix} ] R ( θ ) X + [ \begin{matrix}{c}_{x} \\ {c}_{y}\end{matrix} ] ⇒ [ \begin{matrix}Y \\ 1\end{matrix} ] = {T}_{a} [ \begin{matrix}X \\ 1\end{matrix} ] & ( 3 ) \\ where {T}_{a} = [ \begin{matrix}{S}_{x} {r}_{11} & - {S}_{x} {r}_{12} & {c}_{x} \\ {S}_{y} {r}_{1} & {S}_{y} {r}_{11} & {c}_{y} \\ 0 & 0 & 1\end{matrix} ] & \end{matrix}$$

is a transformation matrix, (Sx, Sy) are scale factors in the x and y directions respectively, R is a rotation matrix with angle (θ), and (cₓ, c_{y}) is the translation in the x and y directions respectively. There are five free parameters: Sₓ, S_{y}, Θ, cₓ, and c_{y}. The affine transform in Equation (3) represents a wide range of transformations. While this flexibility is desirable in some applications, a stricter version of Equation (3) is opted for in this work—the similarity transform—which has four free parameters. The similarity transform is described by the formula

$$Y = SR ( θ ) X + [ \begin{matrix}{c}_{x} \\ {c}_{y}\end{matrix} ] ⇒ [ \begin{matrix}Y \\ 1\end{matrix} ] = {T}_{s} [ \begin{matrix}X \\ 1\end{matrix} ] \qquad ( 4 )$$

where (Sₓ=S_{y}=S).

Due to numerical error tolerances, for splices where Sₓ and S_{y} are similar, equations (3) and (4) have similar performance. This is analyzed in detail with the following example. For a patch centered at (0, 0) whose pixels have been through two different types of scaling operations:

1. Two scale parameters as in equation (3): Sₓ=S_{y} and

$${X}^{a} = [ \begin{matrix}{X}_{x}^{a} \\ {X}_{y}^{a}\end{matrix} ] = [ \begin{matrix}{S}_{x} & 0 \\ 0 & {S}_{y}\end{matrix} ] [ \begin{matrix}{X}_{x} \\ {X}_{y}\end{matrix} ] \qquad ( 5 )$$

2. One scale parameter as in equation (4): S=αSₓ+(1−α)S_{y} where alpha ϵ[0 1] and

$${X}^{s} = [ \begin{matrix}{X}_{x}^{s} \\ {X}_{y}^{s}\end{matrix} ] = [ \begin{matrix}S & 0 \\ 0 & S\end{matrix} ] [ \begin{matrix}{X}_{x} \\ {X}_{y}\end{matrix} ] \qquad ( 6 )$$

where ((·)ₓ, (·)_{y}) are the (x, y) coordinates of the array (·). In this particular case, the effects of scaling are desired, so rotation and translation are ignored. The difference between the locations of the scaled points using the above operations is given by:

r_{d}²=(Xₓ^{a}−Xₓ^{s})²+(X_{y}^{a}−X_{y}^{s})²=(SₓXₓ−SXₓ)²+(S_{y}X_{y}−SX_{y})² (7)

where r_{d} is the distance between the pixel locations of the scaled points. Substituting for S and simplifying yields:

r_{d}²=(Sₓ−S_{y})²((1−α)²Xₓ²+α²X_{y}²) (8)

Let α=0.5 (S is the average of Sₓ and S_{y}) and the above equation reduces to:

r_{d}=\sqrt{¼(Sₓ−S_{y})²(Xₓ²+X_{y}²)}=½|Sₓ−S_{y}|R (9)

where R=\sqrt{Xₓ²+X_{y}²} is the radial distance of pixel locations from the center of the patch.

Per equation (9), the error in the location of the scaled points between the two methods increases linearly with distance from the center of the patch. If a maximum acceptable threshold is set for this difference as η, i.e. r_{d}≤η where the tolerance q is on the order of a pixel, and solve for R, equation (9) yields:

$$\begin{matrix}R \leq \frac{2 η}{\vert {S}_{x} - {S}_{y} \vert} & ( 10 ) \\ where & \\ β = \frac{min \{ {S}_{x} , {S}_{y} \}}{max \{ {S}_{x} , {S}_{y} \}} & ( 11 )\end{matrix}$$

measures the discrepancy between the scale factors.

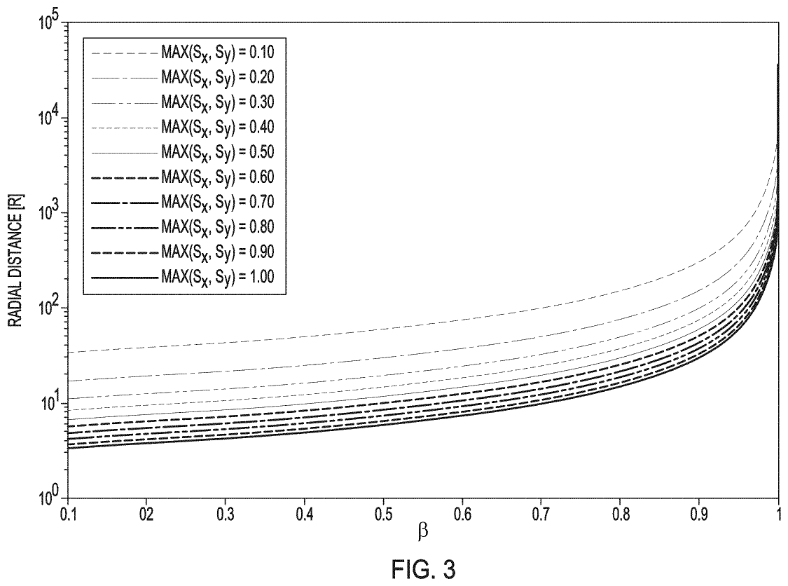

FIG. 3 is a plot of how the radius of the patch varies with β an acceptance threshold η=1.5[pix]. This figure shows that as Sₓ and S_{y} get closer in value (β→1), the region where equation (4) approximates (3) increases for a given value of max (Sₓ, S_{y}). For a given β, excessive scaling reduces the agreement region as coordinate points undergo huge contraction/expansion. Since forgeries involving objects would usually maintain the relationship between the objects dimensions, β values would be close to 1 and thus a wider region of agreement between equations (4) and (3).

The observations from equation (10) together with FIG. 3 motivate the use of equation (4) as transformation between patches in the probe and donor images. For a cluster of points in the probe image (X) and its matching points in the donor image (Y), equation (4) is satisfied if there are at least N=4 points in X that map to Y and the distance between a point and its transformed match is less than 1.5 pixels. For all clusters in the probe image that have matches in the donor image, the total matching error is given as:

$${E}_{match} = \frac{\frac{\frac{1}{N} {\sum }_{i = 1}^{N} {e}_{i}}{J}}{- 1} \begin{matrix}if match found \\ no match found\end{matrix} \qquad ( 12 )$$

where eᵢ is the average matching error of cluster i, N is the number of clusters that found matches and J is the total number of matching points (inliers) across all clusters. The numerator of equation (12) is the average error across all matching clusters. The form of this equation (12) favors (probe, donor) pairs that have strong matches (i.e., many inliers found during cluster matching).

The result of the grouping stage is an initial mask of the probe image showing the regions that overlap with the donor image. Due to the properties of our chosen geometric transform (equation (4)), the initial mask region for a given patch lies in center of the forged points in that cluster but does not cover the entire forged patch. Also, interest points surrounding the initial mask area might be within the forged region, but are not detected by equation (4) because of its strict nature. As such, a more flexible equation that would allow us to include bordering interest points that satisfy a region growing criteria is required.

The following algorithm represents pseudo-code for region growing:

```
Input: Probe image mask (Mₚ)
Input: Probe/donor SIFT descriptors Dₚ/D_{d};
interest points Cₚ, C_{d}
Output: Probe mask (Mₚ); transformation matrix Tₐ
initialization;
grow Mₚ;
N( ) ← 0;
while true do
      dₚ ← subset of Dₚ where Cₚ ϵ Mₚ;
      d_{d} ← subset D_{d} that match d_{d};
      Tₐ ← transformation linking dₚ to d_{d} using equation (3);
      compute area of matching regions from inliers:
      A_{probe}, A_{donor};
      if (Equation No. 13) AND (Equation No. 15) then
            N( ) ← number of inliers in d_{d};
      else
            N( ) ← previous value
      end
      if no change in last 3 N( ) then
            break;
      else
            grow Mₚ;
      end
end while
shrink Mₚ;
return Mₚ, Tₐ;
```

In the above pseudo-code algorithm, an initial mask region is uniformly expanded. The SIFT descriptors of the interest points in this region are collected and matched to those of the donor image. Equation (3) is used to match the point correspondences with a matching error threshold of three pixels, and the resulting transform is noted (Tₐ). The inlier points from the transform are used to get the area of the matching regions (A_{probe};A_{donor}). This transform is accepted if the following conditions are met:

1. The ratio of (largest scale)-to-(smallest scale) should be less than 2.5.

$$\frac{1}{β} \leq 2.5 \qquad ( 13 )$$

where β is defined in equation (11). This disregards scaling that is very unbalanced.

2. The probe-to-donor area ratio should closely match the product of the scaling factors. For a given patch of height H and width W, the area ratio is:

$$\frac{{A}_{probe}}{{A}_{donor}} = \frac{{S}_{x} {S}_{y} HW}{HW} ⇒ \frac{{A}_{probe}}{{A}_{donor}} - {S}_{x} {S}_{y} = 0 \qquad ( 14 )$$

Due to the nature of estimation processes, some approximation of the area ratio is allowed for. As such, equation (14) becomes

$$\vert \frac{{A}_{probe}}{{A}_{donor}} - {S}_{x} {S}_{y} \vert < ϵ \qquad ( 15 )$$

where ϵ=0.05, (15)

If the above conditions are met, the number of inliers in the probe image is noted. The mask region is expanded again and the process repeats. The region growing loop terminates when the number of inliers in the probe image does not increase after three iterations. After the loop ends, the mask (Mₚ) is eroded and the result is returned with the transformation matrix (Tₐ).

In order to achieve ultra-low false positive rates, a novel approach is employed to further suppress false positive detections based on higher-level semantic cues. This method operates on a denser level, using all of the pixels in the splice region, rather than the sparse, keypoints-based description of spliced regions employed up to this point.

The mask (Mₚ) produced from region growing identifies the region in the probe image that is manipulated. The matrix (Tₐ) is the transformation that took the patch in the donor image to the probe image. To find the corresponding patch location in the donor image, the inverse transform of (Tₐ) is applied to the location of the probe patch using:

$$[ \begin{matrix}{X}_{{M}_{d = 1}} \\ 1\end{matrix} ] = {T}_{a}^{- 1} [ \begin{matrix}{X}_{{M}_{d = 1}} \\ 1\end{matrix} ] \qquad ( 16 )$$

where X_{Mp=1} is a (2×N) array of (|x y|^{T}) locations of N-pixels that make up the patch in the probe image and X_{Md=1} is the location of the transformed probe points in the donor image. From both masks, bounding boxes are used to extract the desired patch regions. The extracted patches are used as input to a Convolutional Neural Network (CNN) whose output is a vector of probability values.

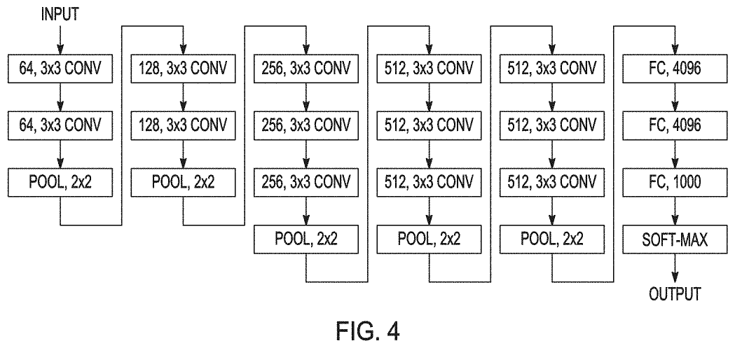

In an embodiment, a CNN of sixteen layers can be used. FIG. 4 shows a block diagram of the network architecture. The network accepts an RGB image of size 224×224×3. This image passes through thirteen convolutional layers with varying numbers of 3×3 filters. Convolution with each filter uses a stride of one pixel and padding is performed at each convolutional layer so that the convolution output preserves the resolution of the image. Five max-pooling layers with filters of size 2×2 are interspersed among the convolutional layers. The maxpooling operation uses a stride of 2. The convolutional layers are followed by three fully connected layers. The first two layers have 4096 channels, and the last layer has 1000 channels relating to the number of image categories in the training dataset. The final layer returns a softmax score for each of the 1000 channels.

Patches extracted after the region growing process are used as input to the CNN, after appropriate resizing. The output of the CNN is a vector of N probability values relating to the labels of the network. If the probe and donor patches are visually similar, then their output vectors should also be similar. The similarity between the two output vectors is expressed using the Bhattacharyya coefficient:

Z=\sqrt{O_{probe}}·\sqrt{O_{donor}} (17)

where O is the output of the CNN and (·) is the dot product. The square root function in the above equation ensures that the vectors are of unit length.

In each splice task, a probe image is checked for the presence of patches from the donor image as described in the preceding sections. A score is generated for this task using the following equation:

score=(1−e^{-z})e^{-E}^{_{match}} (18)

where E_{match} is the error from geometric matching (equation (12)) and Z is defined in equation (17).

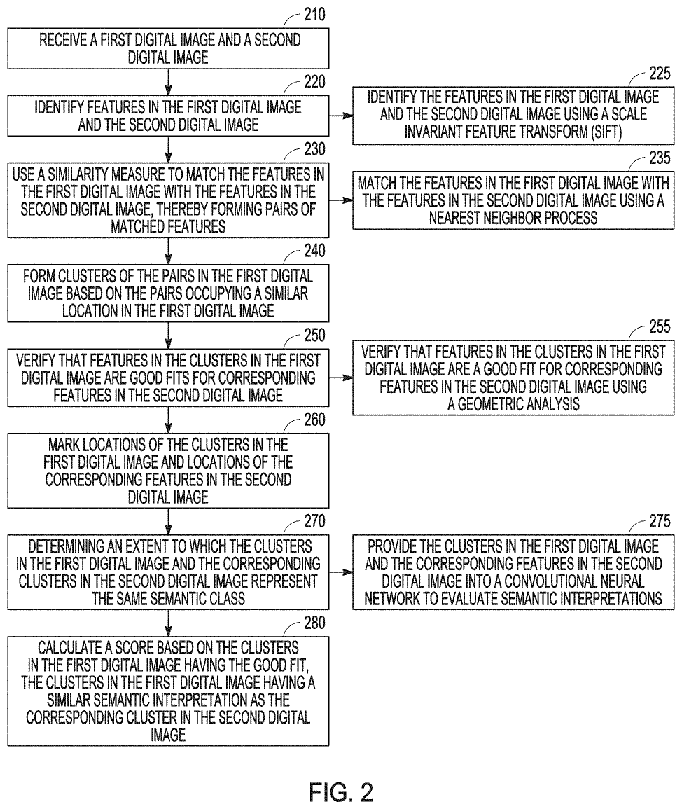

FIG. 2 is a block diagram illustrating operations and features of an image forgery detection method. FIG. 2 includes a number of process blocks 210-285. Though arranged substantially serially in the example of FIG. 2, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIG. 2, at 210, a probe digital image and a donor digital image are received into a computer processor. As noted above, a probe image is the image for which a determination is to be made as to whether a portion of a donor image has been copy-moved or spliced into the probe image. At 220, features in the probe and donor images are identified. Such features can be referred to as distinguishable features, which means that there is something interesting about these features, such as the features represent an object or a person (or some distinguishing feature thereof such as the eyes of a person). As indicated at 225, a scale invariant feature transform (SIFT) can be used to identify the features in the probe image and the donor image.

At 230, a similarity measure is used to match the features in the probe image with the features in the donor image. Upon successful matching of features in the probe image and features in the donor image, pairs of these matched features are formed. As indicated at 235, a nearest neighbor process can be used to match the features in the probe image with the features in the donor image. At 240, in response to forming the pairs of matched features, clusters of the pairs in the probe image are formed based on the pairs occupying a proximate location in the probe image. The proximity can be measured by pairs being within a certain number of pixels of each other, for example, within three pixels of each other.

At 250, it is determined which if any clusters in the probe image are a good fit for the corresponding matches in the donor image. As noted above, a cluster and its corresponding feature were matched up in operation 230. A geometric analysis can be used to determine whether a cluster in the probe image and a matched feature in the donor image are a good fit (255).

At 260, in response to determining that a cluster and a matched feature are a good fit, the physical location of the cluster in the probe image and the physical location of the matched feature in the donor image are marked. Then, at 270, determining the extent to which the cluster in the probe image and the matched feature in the donor image represent the same semantic class. As indicated at 275, the evaluating semantic interpretations operation can be implemented by providing clusters from the probe image and matching features from the donor image into a convolutional neural network (CNN). If the CNN cannot determine that a cluster and a matched feature are from the same semantic class, then it can be concluded that the cluster and the matching feature are an unrelated capture of a similar type of feature.

At 280, a score is calculated based on the clusters in the probe image that had a good fit with their matched features and having a similar semantic interpretation as the corresponding cluster in the second digital image.

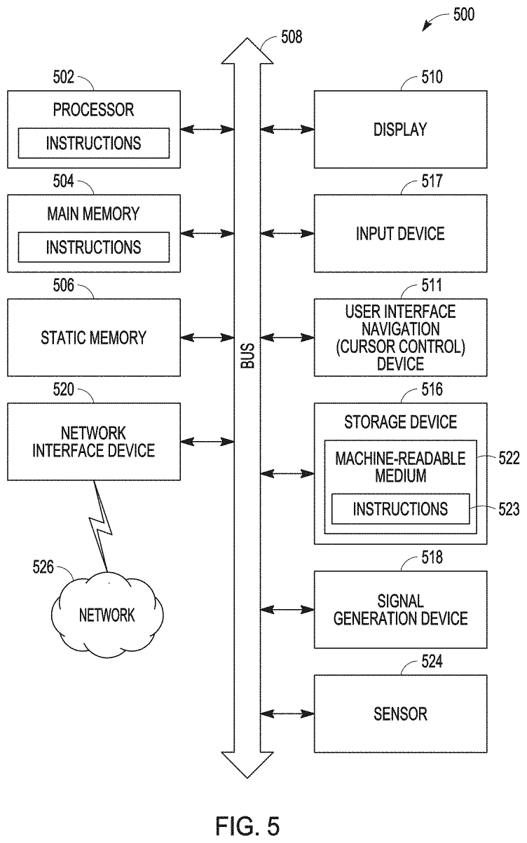

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 501 and a static memory 506, which communicate with each other via a bus 508. The computer system 500 may further include a display unit 510, an alphanumeric input device 517 (e.g., a keyboard), and a user interface (UI) navigation device 511 (e.g., a mouse). In one embodiment, the display, input device and cursor control device are a touch screen display. The computer system 500 may additionally include a storage device 516 (e.g., drive unit), a signal generation device 518 (e.g., a speaker), a network interface device 520, and one or more sensors 521, such as a global positioning system sensor, compass, accelerometer, or other sensor.

The drive unit 516 includes a machine-readable medium 522 on which is stored one or more sets of instructions and data structures (e.g., software 523) embodying or utilized by any one or more of the methodologies or functions described herein. The software 523 may also reside, completely or at least partially, within the main memory 501 and/or within the processor 502 during execution thereof by the computer system 500, the main memory 501 and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 523 may further be transmitted or received over a communications network 526 using a transmission medium via the network interface device 520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A non-transitory computer-readable medium comprising instructions that when executed by a processor execute a process comprising:
receiving into the computer processor a first digital image and a second digital image;
identifying features in the first digital image and the second digital image;
using a similarity measure to match the features in the first digital image with the features in the second digital image, thereby forming pairs of matched features;
in response to forming the pairs of matched features, forming clusters of the pairs in the first digital image based on the pairs occupying a similar location in the first digital image;
verifying that features in the clusters in the first digital image are good fits for corresponding features in the second digital image;
in response to verifying the good fits of the clusters, marking locations of the clusters in the first digital image and locations of the corresponding features in the second digital image;
determining an extent to which the clusters in the first digital image and the corresponding clusters in the second digital image represent same semantic class; and
calculating a score based on the clusters in the first digital image having the good fit and the clusters in the first digital image having a similar semantic interpretation as the corresponding cluster in the second digital image.

2. The non-transitory computer readable medium of claim 1, comprising instructions for identifying the features in the first digital image and the second digital image using a scale invariant feature transform (SIFT).

3. The non-transitory computer readable medium of claim 1, comprising instructions for matching the features in the first digital image with the features in the second digital image using a nearest neighbor process.

4. The non-transitory computer readable medium of claim 1, comprising instructions for verifying that features in the clusters in the first digital image are a good fit for corresponding features in the second digital image using a geometric analysis.

5. The non-transitory computer readable medium of claim 1, comprising instructions for providing the clusters in the first digital image and the corresponding clusters in the second digital image into a convolutional neural network to evaluate semantic interpretations.

6. The non-transitory computer readable medium of claim 1, wherein in the forming clusters of the pairs in the first digital image based on the pairs occupying a similar location in the first digital image, the similar location is determined by the pairs being within a certain number of pixels of each other.

7. A process comprising:
receiving into a computer processor a first digital image and a second digital image;
identifying features in the first digital image and the second digital image;
using a similarity measure to match the features in the first digital image with the features in the second digital image, thereby forming pairs of matched features;
in response to forming the pairs of matched features, forming clusters of the pairs in the first digital image based on the pairs occupying a similar location in the first digital image;
verifying that features in the clusters in the first digital image are good fits for corresponding features in the second digital image;
in response to verifying the good fits of the clusters, marking locations of the clusters in the first digital image and locations of the corresponding features in the second digital image;
determining an extent to which the clusters in the first digital image and the corresponding clusters in the second digital image represent same semantic class; and
calculating a score based on the clusters in the first digital image having the good fit and the clusters in the first digital image having a similar semantic interpretation as the corresponding cluster in the second digital image.

8. The process of claim 7, comprising identifying the features in the first digital image and the second digital image using a scale invariant feature transform (SIFT).

9. The process of claim 7, comprising matching the features in the first digital image with the features in the second digital image using a nearest neighbor process.

10. The process of claim 7, comprising verifying that features in the clusters in the first digital image are a good fit for corresponding features in the second digital image using a geometric analysis.

11. The process of claim 7, comprising providing the clusters in the first digital image and the corresponding clusters in the second digital image into a convolutional neural network to evaluate semantic interpretations.

12. The process of claim 7, wherein in the forming clusters of the pairs in the first digital image based on the pairs occupying a similar location in the first digital image, the similar location is determined by the pairs being within a certain number of pixels of each other.

13. A system comprising:
a computer processor; and
a computer memory coupled to the computer processor;
wherein the computer processor is operable to execute a process comprising:
receiving into the computer processor a first digital image and a second digital image;
identifying features in the first digital image and the second digital image;
using a similarity measure to match the features in the first digital image with the features in the second digital image, thereby forming pairs of matched features;
in response to forming the pairs of matched features, forming clusters of the pairs in the first digital image based on the pairs occupying a similar location in the first digital image;
verifying that features in the clusters in the first digital image are good fits for corresponding features in the second digital image;
in response to verifying the good fits of the clusters, marking locations of the clusters in the first digital image and locations of the corresponding features in the second digital image;
determining an extent to which the clusters in the first digital image and the corresponding clusters in the second digital image represent same semantic class; and
calculating a score based on the clusters in the first digital image having the good fit and the clusters in the first digital image having a similar semantic interpretation as the corresponding cluster in the second digital image.

14. The process of claim 15, comprising identifying the features in the first digital image and the second digital image using a scale invariant feature transform (SIFT).

15. The process of claim 15, comprising matching the features in the first digital image with the features in the second digital image using a nearest neighbor process.

16. The process of claim 15, comprising verifying that features in the clusters in the first digital image are a good fit for corresponding features in the second digital image using a geometric analysis.

17. The process of claim 15, comprising providing the clusters in the first digital image and the corresponding features in the second digital image into a convolutional neural network to execute the false alarm suppression.
